(19) United States
(12) Patent Application Publication
(10) Pub. No.: US 2011/0025439 A1
(43) Pub. Date: Feb. 3, 2011

(54) ACTUATING MAGNET

(76) Inventors: Juergen Rettinger, Gemuenden (DE); Harald Hahn, Neuhuetten (DE); Liebhart Zaiser, Karlstadt (DE); Lorenz Lippert, Gemuenden (DE)

Correspondence Address: KENYON & KENYON LLP, ONE BROADWAY, NEW YORK, NY, 10004, US

(21) Appl. No.: 12/735,737

(22) PCT Filed: Jan. 29, 2009
(86) PCT No.: PCT/EP2009/000557

§ 371 Date: Oct. 20, 2010

(30) Foreign Application Priority Data
Feb. 12, 2008 (DE) 10 2008 008 761.0

(51) Int. Cl. H01F 7/128

(52) U.S. Cl. 335/278

(57) ABSTRACT

An actuating magnet is provided for a magnetic valve for a nonmagnetic pressure pipe, that is connected to at least one pole body, in which an armature is developed, and onto which at least two annular sleeves, having a ring lying between them, are slipped, in whose area a gap is situated that is developed between the armature and the pole body. Thereby, the actuating magnet may be developed in a simple manner by slipping annular sleeves and separating rings onto the pressure pipe.

### FIELD OF THE INVENTION

The present invention relates to an actuating magnet for a magnetic valve having a nonmagnetic pressure pipe, which is connected to at least one pole body, and in which an armature is movably guided.

### BACKGROUND INFORMATION

A fast-acting valve is discussed in German patent document DE 10125811 C2, in which an armature, that actuates a valve slide, is held between a yoke and a cone. An annular space between the cone and the yoke is bounded radially by a coil brace having an associated coil, which is located in a pot that is connected to the cone. Because of the air gap present between the cone and the yoke, sealing is difficult and assembly is complicated.

An electromagnet for a hydraulic valve is discussed in German Laid-Open Document DE 4343879 A1, in which an armature and a pole body are provided in a pressure pipe. Radially outside the armature, a tubular piece is provided either adjacent to the inner wall of the pressure pipe or to the outer wall of the pressure pipe, which functions as an additional pole body. The armature actuating the coil is situated radially, outside the pressure pipe. In this instance too, the complicated assembly process is a disadvantage.

German design patent document DE 20 2005015358 U1 discusses a proportional actuating magnet in which a sealing ring is provided radially outside the armature, between two pole tubes that are at a distance from each other in their longitudinal directions. The magnetic armature is guided on the outer side via a cylinder section of the sealing ring, and the proportional actuating magnet, corresponding to this document, is held together by connecting rods.

It is also believed to be understood from the related art that the pole bodies situated in the axial direction of the magnetic armature are magnetically decoupled, for instance, via a welding connection.

### SUMMARY OF THE INVENTION

It is an object of the exemplary embodiments and/or exemplary methods of the present invention to create an actuating magnet especially for a pilot valve, having a simple construction, which is able to be produced with little effort.

This object is attained by an actuating magnet as set forth herein.

An actuating magnet for a magnetically actuated fluid valve is provided, having a nonmagnetic pressure pipe, which, using at least one pole body, encloses an inner space, in which an armature is movably guided, and onto which at least two magnetizable annular sleeves have been slipped, using a nonmagnetic separating ring. Consequently, the actuating magnet may be developed in a simple manner by slipping annular sleeves and separating rings onto the pressure pipe.

The pressure pipe may be made by deep drawing, whereby a cost-effective production process may be implemented.

In one advantageous embodiment, the separating ring and the annular sleeves are pulled directly onto the pressure pipe, so that a small size may be implemented.

The separating ring and the annular sleeves may support the pressure pipe in the radial direction. This makes it possible to provide the initial pressure in the pressure pipe at low material use for the pressure pipe. Furthermore, it makes it possible to be able to develop the pressure pipe to have a low wall thickness, while nevertheless implementing a mechanically stable accommodation for the armature.

In another embodiment, the inside diameters of the separating ring and the annular sleeves are dimensioned to stress the pressure pipe radially, so there is a largely constant inside diameter of the pressure pipe along the longitudinal axis, whereby the armature is able to move uniformly along the longitudinal axis.

The pressure pipe may have the effect of a magnetic separation between the annular sleeves and the pole body. In this way, a favorable characteristic curve may be implemented.

It is particularly advantageous if the pressure pipe is connected to the pole body in a fluidly sealed manner, so that no sealing is required between the valve housing and the valve slide.

The outside contour of the armature may correspond to a circular cylinder. Thus there are no chambers between the armature and the pole body from which oil has to be displaced.

Radially outside the separating ring, in a special embodiment, a coil brace is provided for a magnetic coil deflecting the armature by plugging it on. Because of this, the assembly of the actuating magnet is able to take place using little assembly effort.

The actuating magnet may be provided with a pole disk adjacent to the coil brace which, together with an outer sleeve shaped like a beaker, forms the housing of the actuating magnet. This further simplifies the mechanical combination of the actuating magnet.

In one further specific embodiment, one of the annular sleeves has a bending collar which projects into a rounded recess of the pole disk. One may thereby balance out length tolerances between the annular sleeves and the components forming the housing that was mentioned. In addition, an axial bracing of the annular sleeves and the separating ring may be achieved.

Alternatively, one of the annular sleeves (40) may be pressed into a recess in pole disk 58 at an end section. This has the effect of a secure hold of the annular sleeve on the pole disk, and a tolerating of length as well as a static bracing of the annular sleeves and the separating ring are also possible.

The separating surface between the separating ring and the annular sleeve may be an annular surface aligned perpendicularly to the longitudinal axis of the pressure pipe. Production becomes particularly simple and the pole shape thus achieved, in certain cases already yields a largely linear force-displacement characteristic curve.

The separating surface between the separating ring and the annular sleeve is able to be an annular surface placed conically with respect to the longitudinal axis of the pressure pipe, so that a desired pole shape may be produced in a simple manner.

The actuating magnet may be developed as a double-stroke magnet, a third magnetizable annular sleeve and an additional nonmagnetic separating ring separating it from the other annular sleeves being provided. Therefore, an actuating magnet for reliable actuation at low production costs may be provided, without undertaking any welding work.

Further developments according to the exemplary embodiments and/or exemplary methods of the present invention constitute the subject matter of further described herein.

The exemplary embodiments and/or exemplary methods of the present invention is described below, with reference to the accompanying figures.

### BRIEF DESCRIPTION OF THE DRAWINGS

FIG. 1 shows a sectional representation of the actuating magnet according to the present invention, with the aid of a first exemplary embodiment, sectional view.

FIG. 2 shows a sectional representation of the actuating magnet according to the present invention, with the aid of a second exemplary embodiment.

### DETAILED DESCRIPTION

In the first figure, an actuating magnet 1 is shown, which has a pole tube 2 in a housing 4, for actuating a valve slide 8 situated in a valve housing 6. A cylindrical pressure pipe 12, which form a part of pole tube 2, is set onto valve housing 6 and is sealed from it by a sealing ring 10.

Pressure pipe 12 is developed from a nonmagnetic material having a low wall thickness, and is widened at its end section pointing towards valve housing 6, so as to facilitate the application of pressure pipe 12 onto valve housing 6. At its end face opposite end section 14, a recess is provided into which a pole body 18, which is essentially cylindrical, is introduced, so that it may close flush with end face 16 of pressure pipe 12. Pole body 18 is sealed from pressure pipe 12 by a sealing ring. End face 22 of pole body 18, pointing towards valve housing 6, is annularly developed to have a projection 24, a ring disk 26 having an anti-stick function being provided onto end face 22.

Armature 28 is guided between valve housing 6 and pole body 18 sliding on the inner surface of pressure pipe 12, and has a continuous recess 30 having a stepped section 32, on which a spring 34 is supported that is set onto projection 24 of pole body 18, so that armature 28 is prestressed with respect to valve housing 6 because of spring 34. A disk 36 is set onto the end face of armature 28 pointing to the valve housing, and in the middle of the disk, valve slide 8 is supported. Because of spring 34, a prestressing force is exerted on valve slide 8, via armature 28 and disk 36, so that it moves to the left in the figure.

Although this is not shown in the figure, valve slide 8 is prestressed at its end section opposite to the contact surface with disk 36, with respect to valve housing 6 in the opposite direction, that is, to the right in the figure. As a result, after an excursion, the armature returns again to its middle setting, as shown in the figure.

Valve slide 8 is pressure-equalized, the system pressure being present in the pressure pipe, i.e. both between valve housing 6 and armature 28 and between pole body 18 and armature 28. Since the bordering surfaces between disk 36 and valve housing 6, as well as between disk 26 and armature 28 are developed as planes, they do not intermesh, so that adhesion is prevented. Furthermore, because of this, the operation of the actuating magnet is also possible when the oil is cold and viscous. The diameter of continuous recess 30 in the armature is selected in such a way that a reliable exchange of hydraulic fluid via it may be performed. Thus, no chambers exist between armature 28, pole body 18 and valve housing 6, from which hydraulic fluid is able to be squeezed out at a great time delay.

Three annular sleeves 44 are mounted on the outer circumference of pressure pipe 12 in the longitudinal direction of armature 28, between which there are two separating rings 46, 48. Separating rings 46, 48 are not ferromagnetic, while the annular sleeves are developed of ferromagnetic material. The cross section of separating rings 46, 48 is rectangular and the end faces of separating rings 46, 48 running in the radial direction are in contact with end faces of the bordering annular sleeves 40, 42, 44. Annular sleeve 40 bordering on valve housing 6 has a bending collar 50, that lies against valve housing 6 via a flange section 52 and is able to be bent inwards, so that annular sleeve 40 is able to be held securely at valve housing 6. Bending collar 52 also accommodates end section 14 of pressure pipe 12. Annular sleeve 44, that borders on end face 16 of pressure pipe 12, has a flange section 53, via which annular sleeve 44 is able to be supported on housing 4.

Annular sleeves 40, 42, 44, having interposed separating rings 46 and 48, are slipped onto pressure pipe 12, so that they support relatively weakly dimensioned pressure pipe 12 in the radial direction. Since the pressure pipe is nonmagnetic, the pole shape is determined by the design of the contiguous end faces of annular sleeves 40, 42, 44 and separating rings 46, 48.

Coil braces 54, 56 are provided radially outside annular sleeves 40, 42, 44 and separating rings 46, 48, and these coil braces 54, 56, which are separated by a middle pole disk 58′, which is located approximately centrically with respect to armature 28 in the middle position of armature 28 shown in the figure, whereas coil brace 54 situated at the left in the figure is bordered on the left side by pole disk 58 that forms a part of housing 4.

Pole disk 58 has a rounded annular recess 60 for accommodating and developing bending collar via flange section 52. At the outer circumferential surface of pole disk 58 there is an annular accommodation 62 for accommodating an outer shell 64 that is developed to be pot-shaped. Outer shell 64 is applied into annular accommodation 62 under stress, in this context, so that they are connected in a manner that is mechanically stable. Consequently, coil brace 54, pole disk 58′, coil brace 56 and flange section 53 are held between a base surface 66 of outer shell 64 and pole disk 58.

Bending collar 50 of annular sleeve 14 projects into annular recess 60 of pole disk 58. Annular sleeves 40, 42, 44 and separating rings 46, 48 are dimensioned in such a way that they are in contact with one another, when outer shell 64 is applied onto pole disk 58, and at the same time pressure pipe 12 is held adjacent to base section 66 of outer shell 64. Thin bending collar 50, that is able to be bent inwards, is used in this context for securing (the mechanism) axially.

Pressure pipe 12 may be developed as a deep drawn part, so that, conditioned upon its production, the material strength changes in the longitudinal direction. A conical inside diameter of pressure pipe 12 is not desirable, however. The conicity based on the development of the pressure pipe as a deep drawn part may be compensated for by a suitable choice of the inside diameters of annular sleeves 40, 42, 44 and separating rings 46, 48. For this purpose, the separating rings and the annular sleeves are pressed onto pressure pipe 12, the pressure seats being selected so that the pressure pipe is deformed in the direction of becoming a cylinder. As a result, one obtains an essentially cylindrical inner diameter of pressure pipe 12, which makes possible a stable run of armature 28.

Separating rings 46, 48 are developed in the longitudinal direction of coil braces 54, 56 in such a way that, in the assembled state, annular sleeve 40 projects in the longitudinal direction of the actuating magnet via valve housing 6 towards the armature, and that annular sleeve 44 projects beyond pole body 18 in the longitudinal direction all the way to armature 28. Pressure pipe 12, lying in between, ensures a magnetic separation between annular sleeves 40, 44 and corresponding pole body 18 or the section of valve housing 6 used as pole body. This separates the magnetic flux into an inner component running via pole body 18, or the part of valve housing 6 acting as a pole body, and an outer component running via annular sleeves 40, 44. By doing this, a linearization of the force-displacement characteristic is achieved in this exemplary embodiment.

The magnetic flux with respect to coil brace 54 runs from armature 28 via annular sleeve 42, middle pole disk 58′, outer shell 64, pole disk 58, and then subdivided via valve housing 6 and via annular sleeve 40 having the associated gap back to armature 28. In the same way, the magnetic flux with respect to coil brace 56 runs from armature 28 via annular sleeve 42, middle pole disk 58′, outer shell 64, and then subdivided via annular sleeve 44 and pole body 18 back to the armature.

In the actuating magnet shown in the figure, a double-stroke magnet is shown. In the case of the latter, the plugging-together principle is able to be used particularly advantageously. In particular, one may do without the development of welding locations on the pole pipe.

The exemplary embodiments and/or exemplary methods of the present invention is not, however, limited to double-stroke magnets. Alternatively, one may also just provide a coil brace and two annular sleeves having a separating ring placed in between. In this case it is advantageous if only a spring for exerting a prestressing on the armature is provided.

The exemplary embodiments and/or exemplary methods of the present invention may be used in pilot valves for hoisting gear control of automotive equipment.

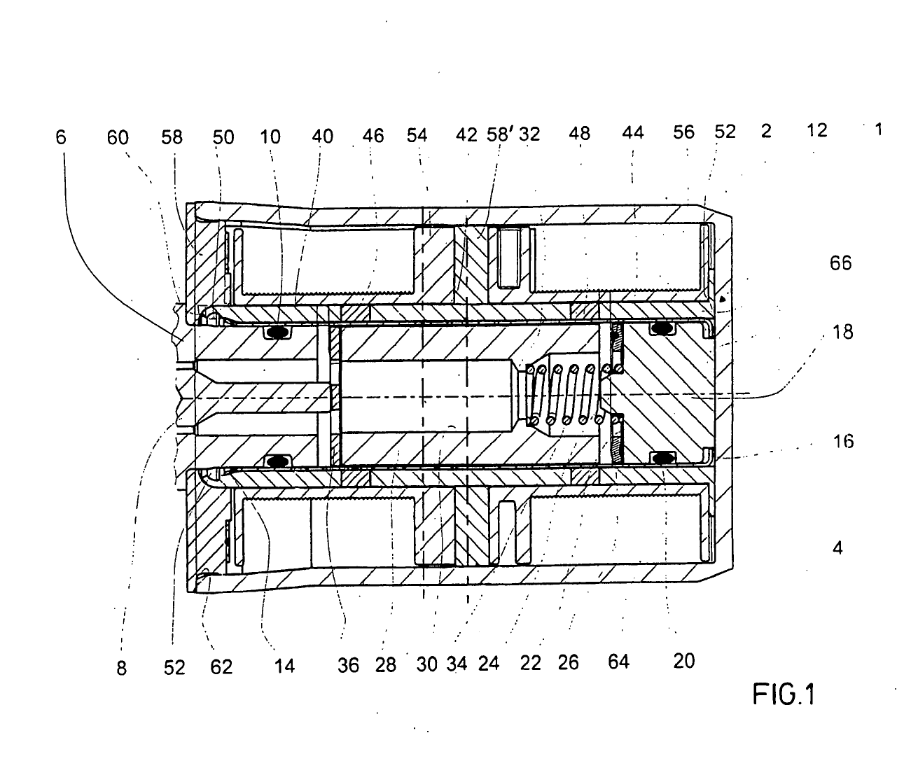

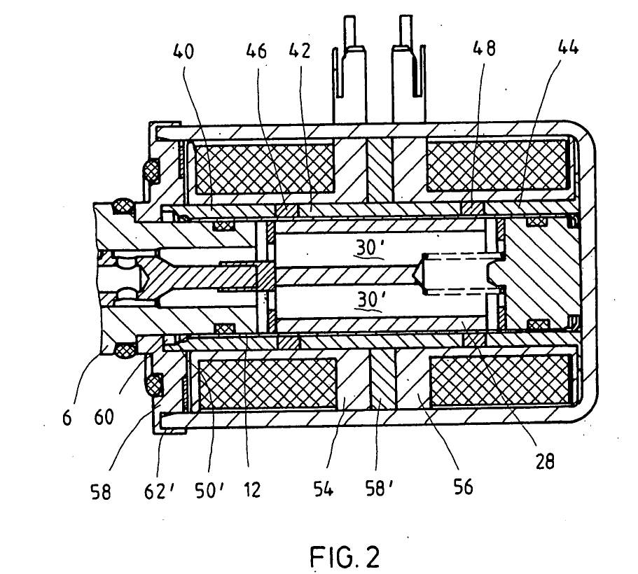

FIG. 2 shows a second exemplary embodiment, which agrees with the first exemplary embodiment described with reference to FIG. 1, except for modifications described below. The modifications are predominantly for the purpose of further simplification of production and assembly, as well as broadening the range of applications.

On valve housing 6 a pole disk 58 has been mounted, using press fitting. Pole disk 58 has an annular inner recess 60, and an annular groove type of undercut 62′ near its outer circumference. Pressure pipe 12 is furthermore slipped onto valve housing 6. In a manner described before, annular sleeves 40, 42 and 44 and separating rings 46 and 48, lying between them, are situated on pressure pipe 12. Annular sleeve 40 has an end section 50′, which undergoes a press fitting together with inner recess 60.

Radially outside annular sleeves 40, 42 and 44, coil braces 54, 56 and middle pole disk 58′ are situated. An outer shell 64 encompassing the equipment made up of annular sleeves 40, 42 and 44, pressure pipe 12, as well as coil braces 54, 56, etc. is inserted into annular groove-type undercut 62′, and crimped in it point-by-point.

Armature 28 has the outer contour of a circular cylinder. There are two through-bores 30′ which permit the passage of pressure media.

Recess 60 on pole disk 58 has a sufficiently great depth so that an equalization of the length tolerances of annular sleeves 40, 42 and 44 and separating rings 46 and 48 is achieved with respect to the inner dimension of the housing formed by pole disk 58 and outer shell 64.

An actuating magnet is provided for a magnetic valve for a nonmagnetic pressure pipe, that is connected to at least one pole body, in which an armature is developed, and onto which at least two annular sleeves, having a ring lying between them, are slipped, in whose area a gap is situated that is developed between the armature and the pole body. Thereby, the actuating magnet may be developed in a simple manner by slipping annular sleeves and separating rings onto the pressure pipe.

The List of Reference Numerals is as follows:
1 actuating magnet
2 pole pipe
4 housing
6 valve housing
8 valve slide
10 sealing ring
12 pressure pipe
14 end section
16 end face
18 pole body
20 sealing ring
22 end face
24 projection
26 annular disk
28 armature
30 continuous recess
32 stepped section
34 spring
36 disk
40 annular sleeve
42 annular sleeve
44 annular sleeve
46 separating ring
48 separating ring
50 bending collar
50′ end section
52 flange section
53 flange section
54 coil brace
56 coil brace
58 pole disk
58′ pole disk
60 annular recess
62 annular accommodation
62′ undercut
64 outer sleeve
66 base

1-16. (canceled)

17. An actuating magnet for a magnetically operated fluid valve, comprising:
at least one pole body;
an armature;
at least two magnetizable annular sleeves;
a non-magnetic separating ring; and
a nonmagnetic pressure pipe, which, together with the at least one pole body, encloses an inner space, in which the armature is movably guided, and onto which the at least two magnetizable annular sleeves have been slipped, along with the non-magnetic separating ring lying between the at least two magnetizable annular sleeves.

18. The actuating magnet of claim 17, wherein the pressure pipe is produced by deep drawing.

19. The actuating magnet of claim 17, wherein the separating ring and the annular sleeves are slipped directly onto the pressure pipe.

20. The actuating magnet of claim 17, wherein the separating ring and the annular sleeves support the pressure pipe in the radial direction.

21. The actuating magnet of claim 17, wherein the inside diameters of the separating ring and of the annular sleeves are dimensioned so as to prestress the pressure pipe radially, so that there is an inside diameter of the pressure pipe that is constant to the greatest extent along the longitudinal axis.

22. The actuating magnet of claim 17, wherein a magnetic separation between the annular sleeves and the pole body is effected by the pressure pipe.

23. The actuating magnet of claim 17, wherein the pressure pipe is connected to the pole body in a fluid-tight manner.

24. The actuating magnet of claim 17, wherein an outer contour of the armature corresponds to a circular cylinder.

25. The actuating magnet of claim 17, further comprising:
a coil brace for a magnetic coil that causes an excursion of the armature, wherein the coil brace is slipped on radially outside the separating ring.

26. The actuating magnet of claim 25, further comprising:
a pole disk, which is adjacent to the coil brace and which, together with an outer shell that is shaped like a beaker, forms a housing of the actuating magnet.

27. The actuating magnet of claim 26, wherein one of the annular sleeves has a bending collar, which projects into a rounded recess of the pole disk.

28. The actuating magnet of claim 27, wherein an overall length of the annular sleeves and of the separating ring has such an oversize, as compared to a housing inner space defined by the outer shell and the pole disk, that the bending collar lies against the rounded recess of the pole disk while being deformed, when the outer shell is clamped in in the direction of the pole disk.

29. The actuating magnet of claim 26, wherein one of the annular sleeves is pressed into a recess in the pole disk at one end section.

30. The actuating magnet of claim 17, wherein the separating surface between the separating ring and the annular sleeve is an annular surface aligned perpendicularly to the longitudinal axis of the pressure pipe.

31. The actuating magnet of claim 17, wherein the separating surface between the separating ring and the annular sleeve is an annular surface placed conically to the longitudinal axis of the pressure pipe.

32. The actuating magnet of claim 17, further comprising:
a third magnetizable annular sleeve;
an additional, nonmagnetic separating ring, which separates the former from the other annular sleeves;
wherein the actuating magnet is configured as a double-stroke magnet.
